(19) United States
(12) Patent Application Publication
(10) Pub. No.: US 2024/0352733 A1
(43) Pub. Date: Oct. 24, 2024

(54) ROOFING SYSTEM INCLUDING ROOFING SHINGLE, AND ASSOCIATED METHOD

(71) Applicant: BMIC LLC, Dallas, TX (US)

(72) Inventor: Ramil Marcelo L. Mercado, Waxahachie, TX (US)

(21) Appl. No.: 18/624,819

(22) Filed: Apr. 2, 2024

Related U.S. Application Data
(60) Provisional application No. 63/497,585, filed on Apr. 21, 2023.

(51) Int. Cl. E04D 1/20; E04D 1/28; H01Q 1/22; H01Q 1/44

(52) U.S. Cl. CPC E04D 1/20; E04D 1/28; H01Q 1/2208; H01Q 1/44

(57) ABSTRACT

A roofing shingle includes a first shingle portion having a base portion, and a plurality of tooth portions extending from the base portion, where the plurality of tooth portions includes at least a first tooth portion, a second shingle portion positioned to at least partially overlap the first shingle portion; a first adhesive line between the first tooth portion and the second shingle portion, and an RFID tag in the first adhesive line.

### CROSS-REFERENCE TO RELATED APPLICATION

This application claims priority to U.S. provisional application No. 63/497,585, titled “ROOFING SYSTEM INCLUDING ROOFING SHINGLE, AND ASSOCIATED METHOD,” filed Apr. 21, 2023, the disclosure of which is incorporated by reference herein in its entirety.

### FIELD

The present invention relates to a roofing system, and, more particularly, to a roofing system including a roofing shingle.

### BACKGROUND

Known roofing systems include roofing shingles installed above a roof deck.

### SUMMARY

The Claims, rather than the Summary, define covered embodiments of the present invention. The Summary is a high-level overview of various aspects of the invention, and introduces some concepts that are further described in the Detailed Description below. The Summary is not intended to identify key or essential features of the claimed subject matter, and also is not intended to be used in isolation to determine the scope of the claimed subject matter. Instead, the claimed subject matter should be understood by reference to appropriate portions of the Specification and drawings, as well as to each claim.

In some embodiments, the present invention provides a roofing shingle, comprising: a first shingle portion, comprising: a base portion, having a top surface and a bottom surface opposite the top surface; and a plurality of tooth portions, wherein the plurality of tooth portions comprises at least a first tooth portion, wherein each of the plurality of tooth portions has a top surface and a bottom surface opposite the top surface, wherein each of the plurality of tooth portions extends from the base portion; a second shingle portion, having a top surface and a bottom surface opposite the top surface; a first adhesive line between the bottom surface of the first tooth portion and the top surface of the second shingle portion; and an RFID tag in the first adhesive line.

In some embodiments, the RFID tag is fully within an interior of the first adhesive line.

In some embodiments, the RFID tag is on a surface of the first adhesive line.

In some embodiments, the RFID tag is on the bottom surface of the first tooth portion.

In some embodiments, the RFID tag is on the top surface of the second shingle portion.

In some embodiments, the first adhesive line comprises an asphalt-based adhesive or a non-asphalt-based adhesive.

In some embodiments, the first shingle portion comprises: a substrate, having a top surface and a bottom surface opposite the top surface; an asphalt-filled layer on the top surface of the substrate; and a plurality of granules on the asphalt-filled layer, to form an uppermost surface.

In some embodiments, the substrate comprises a fiberglass mat.

In some embodiments, the roofing shingle further comprises a second adhesive line between the bottom surface of the first tooth portion and the top surface of the second shingle portion, wherein the first adhesive line is closer to the base portion than the second adhesive line.

In some embodiments, the roofing shingle further comprises a third adhesive line between the bottom surface of the base portion and the top surface of the second shingle portion.

In some embodiments, the plurality of tooth portions comprises a second tooth portion.

In some embodiments, the present invention provides a roofing shingle, comprising: a layer, comprising: a substrate, having a top surface and a bottom surface opposite the top surface; a first asphalt-filled layer on the top surface of the substrate; a plurality of granules on the first asphalt-filled layer, to form an uppermost surface, wherein the uppermost surface comprises: a headlap portion, a nail zone, and a reveal portion; and an RFID tag on the substrate.

In some embodiments, the RFID tag is on the top surface of the substrate.

In some embodiments, the RFID tag is on the bottom surface of the substrate.

In some embodiments, the roofing shingle further comprises a bottom layer on the bottom surface of the substrate.

In some embodiments, the layer further comprises: a second asphalt-filled layer on the bottom surface of the substrate.

In some embodiments, the layer further comprises: a bottom layer on the second asphalt-filled layer.

In some embodiments, the substrate comprises a fiberglass mat.

In some embodiments, the RFID tag is below the headlap portion.

In some embodiments, the RFID tag is below the reveal portion.

### BRIEF DESCRIPTION OF THE FIGURES

This section refers to the drawings that form a part of this disclosure, and which illustrate some of the embodiments of structure, materials, and/or methods of the present invention described herein.

FIG. 1 shows a top view of a roofing shingle, according to some embodiments.

FIG. 2 shows a bottom view of the roofing shingle of FIG. 1, according to some embodiments.

FIG. 3 shows a cross-sectional view of the roofing shingle of FIG. 1, according to some embodiments.

FIG. 4 shows a top view of a roofing shingle including a first shingle portion and a second shingle portion, according to some embodiments.

FIG. 5 shows a bottom view of the first shingle portion of the roofing shingle of FIG. 4, according to some embodiments.

FIG. 6 shows a bottom view of the roofing shingle of FIG. 4, according to some embodiments.

FIG. 7 shows a cross-sectional view of a bottom layer and an adhesive line of the roofing shingle of FIG. 4, according to some embodiments.

FIG. 8 shows a cross-sectional view of a bottom layer and an adhesive line of the roofing shingle of FIG. 4, according to some embodiments.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

Throughout the Specification, including the Detailed Description and Claims, the following terms take the meanings explicitly associated herein, unless the context dictates otherwise. The phrases “in an embodiment,” “in some embodiments,” and any similar phrase, as used herein, do not necessarily refer to the same embodiment or embodiments, though the phrases may refer to the same embodiment or embodiments. Furthermore, the phrases “in another embodiment,” and any similar phrase, as used herein, do not necessarily refer to a different embodiment, although the phrases may refer to a different embodiment. All embodiments of the disclosure are intended to be combinable without departing from the scope or spirit of the disclosure.

As used herein, terms such as “comprising,” “including,” “having,” “with,” and any similar phrase or phrases, do not limit the scope of a specific claim to the materials or steps recited by the claim.

As used herein, a “steep slope” roof or roof deck has a pitch of Y/X, where Y and X are in a ratio of 4:12 to 20:12, where Y corresponds to the “rise” of the roof or roof deck, and where X corresponds to the “run” of the roof or roof deck.

As used herein, a “sloped” roof or roof deck has a pitch greater than zero, but the pitch is less than that of a steep slope roof or roof deck.

As used herein, a “flat” roof or roof deck has a pitch of zero.

In some embodiments, the present invention provides a roofing material including an RFID tag.

In some embodiments, the RFID tag is within an interior of the roofing material. In some embodiments, the RFID tag is embedded fully or entirely within an interior of the roofing material. In some embodiments, the RFID tag is embedded at least partially within an interior of the roofing material. In some embodiments, the RFID tag is between layers of the roofing material. In some embodiments, the RFID tag is on a surface of the roofing material. In some embodiments, the RFID tag is on a top surface of the roofing material. In some embodiments, the RFID tag is on a bottom surface of the roofing material.

In some embodiments, the roofing material is installed above or on a steep slope roof or roof deck. In some embodiments, the roofing material is installed above or on a sloped roof or roof deck. In some embodiments, the roofing material is installed above or on a flat roof or roof deck.

In some embodiments, the roofing material comprises a roofing shingle. In some embodiments, the roofing shingle comprises a tabbed roofing shingle. In some embodiments, the roofing shingle comprises a three-tab roofing shingle. In some embodiments, the roofing shingle comprises a laminated roofing shingle. In some embodiments, the roofing shingle comprises an architectural roofing shingle. In some embodiments, the roofing shingle comprises a hip roofing shingle. In some embodiments, the roofing shingle comprises a ridge roofing shingle. In some embodiments, the roofing shingle comprises a cap roofing shingle.

In some embodiments, the roofing material comprises a roll of material. In some embodiments, the roll of material comprises an underlayment. In some embodiments, the roll of material comprises a membrane.

In some embodiments, the roofing shingle comprises a substrate. In some embodiments, the substrate comprises a top surface, and a bottom surface opposite the top surface. In some embodiments, the RFID tag is on a surface of the substrate. In some embodiments, the RFID tag is on a top surface of the substrate. In some embodiments, the RFID tag is on a bottom surface of the substrate. In some embodiments, the RFID tag is embedded partially or fully within an interior of the surface of the substrate.

In some embodiments, the substrate comprises one or more of a cellulosic substrate, a woven mat, a fabric, a nonwoven fabric, a glass mat, a fiberglass mat, a polyester mat, a scrim, a polymeric scrim, a coated scrim, a bitumen substrate, another material, and/or combinations thereof.

In some embodiments, an asphalt-filled layer is on at least one surface of the substrate. In some embodiments, the asphalt-filled layer is on the top surface of the substrate. In some embodiments, the asphalt-filled layer is on the bottom surface of the substrate. In some embodiments, the asphalt-filled layer is on the top surface of the substrate, and the bottom surface of the substrate.

In some embodiments, the asphalt-filled layer comprises asphalt and a filler material. In some embodiments, the filler comprises limestone (calcium carbonate). In some embodiments, the filler comprises barium sulfate, calcium sulfate, talc, limestone, perlite, silica, fumed silica, precipitated silica, quartz, aluminum trihydrate, magnesium hydroxide, colemanite, titanium dioxide, fly ash, graphene nanoparticles, carbon black, recycled rubber tires, recycled shingles, recycled thermoplastic resins, basalt, roofing granules, clay, lignin, and/or combinations thereof. In some embodiments, the asphalt comprises one or more of blown asphalt, polymer-modified asphalt (PMA), PMA with poly(styrene-butadiene-styrene) (SBS), PMA with poly(styrene-ethylene-styrene) (SEBS), PMA with styrene-butadiene rubber (SBR), PMA with atactic polypropylene, PMA with isotactic polypropylene (IPP), PMA with amorphous polyaliphatic olefin (APAO), PMA with ethylene vinyl acetate (EVA), PMA with polyethylene (PE), PMA with polyvinyl butyral (PVB), asphalt with ground tire rubber (GTR), and/or combinations thereof.

In some embodiments, a non-asphaltic filled layer is on at least one surface of the substrate. In some embodiments, the non-asphaltic filled layer is on the top surface of the substrate. In some embodiments, the non-asphaltic filled layer is on the bottom surface of the substrate. In some embodiments, the non-asphaltic filled layer is on the top surface of the substrate, and the bottom surface of the substrate. In some embodiments, the filler comprises limestone (calcium carbonate). In some embodiments, the filler comprises barium sulfate, calcium sulfate, talc, limestone, perlite, silica, fumed silica, precipitated silica, quartz, aluminum trihydrate, magnesium hydroxide, colemanite, titanium dioxide, fly ash, graphene nanoparticles, carbon black, recycled rubber tires, recycled shingles, recycled thermoplastic resins, basalt, roofing granules, clay, lignin, and/or a combinations thereof.

In some embodiments, the non-asphaltic layer is comprised of a crude tall oil-based material, a resinous hardening agent, and at least one polymer. In some embodiments, the crude tall oil-based continuous phase material comprises tall oil pitch, tall oil pitch blends, distilled tall oil, tall oil pitch blends with low sterols, crude tall oil, or a combination thereof. In some embodiments, the resinous hardening agent comprises esters of maleated rosin with pentaerythritol or stabilized pentaerythritol ester of rosin-based tackifier; rosin, maleated, polymer with glycerol; resin acids and rosin acids, esters with pentaerythritol; modified rosin ester; pentaerythritol ester of rosin; alpha methyl styrene tall oil resin; or a combination thereof. In some embodiments, the polymer comprises poly(styrene-butadiene-styrene) (SBS), poly(styrene-ethylene-butylene-styrene) (SEBS), ethylene-vinyl acetate copolymer (EVA), polyvinyl butyral (PVB), or a combination thereof.

In some embodiments, the RFID tag is on a surface of the asphalt-filled layer which is on the top surface of the substrate. In some embodiments, the RFID tag is on the surface of the asphalt-filled layer that is in contact with the top surface of the substrate (for example, a lower or lowermost surface of the asphalt-filled layer). In some embodiments, the RFID tag is on the surface of the asphalt-filled layer that is opposite to the surface of the asphalt-filled layer that is in contact with the top surface of the substrate (for example, an upper or uppermost surface of the asphalt-filled layer). In some embodiments, the RFID tag is embedded at least partially within the interior of the asphalt-filled layer on the top surface of the substrate. In some embodiments, the RFID tag is embedded fully within the interior of the asphalt-filled layer on the top surface of the substrate.

In some embodiments, the RFID tag is on a surface of the asphalt-filled layer on the bottom surface of the substrate. In some embodiments, the RFID tag is on the surface of the asphalt-filled layer that is in contact with the bottom surface of the substrate (for example, an upper or uppermost surface of the asphalt-filled layer). In some embodiments, the RFID tag is on the surface of the asphalt-filled layer that is opposite to the surface of the asphalt-filled layer in contact with the bottom surface of the substrate (for example, a lower or lowermost surface of the asphalt-filled layer). In some embodiments, the RFID tag is embedded at least partially within the interior of the asphalt-filled layer on the bottom surface of the substrate. In some embodiments, the RFID tag is embedded fully within the interior of the asphalt-filled layer on the bottom surface of the substrate.

In some embodiments, the RFID tag is on a surface of the non-asphaltic filled layer which is on the top surface of the substrate. In some embodiments, the RFID tag is on the surface of the non-asphaltic filled layer that is in contact with the top surface of the substrate (for example, a lower or lowermost surface of the asphalt-filled layer). In some embodiments, the RFID tag is on the surface of the non-asphaltic filled layer that is opposite to the surface of the non-asphaltic filled layer that is in contact with the top surface of the substrate (for example, an upper or uppermost surface of the asphalt-filled layer). In some embodiments, the RFID tag is embedded at least partially within the interior of the non-asphaltic filled layer on the top surface of the substrate. In some embodiments, the RFID tag is embedded fully within the interior of the non-asphaltic filled layer on the top surface of the substrate.

In some embodiments, the RFID tag is on a surface of the non-asphaltic filled layer on the bottom surface of the substrate. In some embodiments, the RFID tag is on the surface of the non-asphaltic filled layer that is in contact with the bottom surface of the substrate (for example, an upper or uppermost surface of the asphalt-filled layer). In some embodiments, the RFID tag is on the surface of the non-asphaltic filled layer that is opposite to the surface of the non-asphaltic filled layer in contact with the bottom surface of the substrate (for example, a lower or lowermost surface of the asphalt-filled layer). In some embodiments, the RFID tag is embedded at least partially within the interior of the non-asphaltic filled layer on the bottom surface of the substrate. In some embodiments, the RFID tag is embedded fully within the interior of the non-asphaltic filled layer on the bottom surface of the substrate.

In some embodiments, a plurality of granules is on the asphalt-filled layer. In some embodiments, when the plurality of granules is on the asphalt-filled layer that is on the top surface of the substrate, the plurality of granules on the asphalt-filled layer forms an uppermost surface of the roofing shingle.

In some embodiments, the RFID tag is within the plurality of granules. In some embodiments, the RFID tag is at least partially embedded within the plurality of granules. In some embodiments, the RFID tag is fully embedded within the plurality of granules. In some embodiments, the RFID tag is on a top surface of the plurality of granules.

In some embodiments, the granules comprise crushed stone, such as basalt or granite. In some embodiments, the granules comprise andesite, nepheline syenite, another material, and/or combinations thereof.

In some embodiments, the uppermost surface of the roofing shingle comprises a headlap portion, a nail zone, and a reveal portion. In some embodiments, at least a portion of the headlap portion of the roofing shingle is configured to be covered by another roofing shingle, when the roofing shingle is installed above the roof deck in a roofing system. In some embodiments, at least a portion of the reveal portion of the roofing shingle is configured to be exposed to the environment when the roofing shingle is installed above the roof deck in the roofing system. In some embodiments, the nail zone of the roofing shingle is configured to receive one or more fasteners, such as but not limited to one or more nails, screws, staples, and/or rivets, and combinations thereof, to fasten the roofing shingle to the roof deck in the roofing system, whether or not the roofing system includes an underlayment and/or any other intervening layer or layers between the roofing shingle and the roof deck.

In some embodiments, the roofing shingle comprise a bottom layer. In some embodiments, the bottom layer is on the bottom surface of the substrate. In some embodiments, the bottom layer is on the asphalt-filled layer that is on the bottom surface of the substrate.

In some embodiments, the RFID tag is on a surface of the bottom layer. In some embodiments, the RFID tag is on the surface of the bottom layer that is in contact with the bottom surface of the substrate or the asphalt-filled layer on the bottom surface of the substrate (for example, an upper or uppermost surface of the bottom layer). In some embodiments, the RFID tag is the surface of the bottom layer that is opposite to the surface of the bottom layer in contact with the bottom surface of the substrate or the asphalt-filled layer on the bottom surface (for example, a lower or lowermost surface of the bottom layer). In some embodiments, the RFID tag is embedded at least partially within the interior of the bottom layer. In some embodiments, the RFID tag is embedded fully within the interior of the bottom layer.

In some embodiments, the bottom layer comprises a polymer film. In some embodiments, the polymer comprises one or more of polyethylene, polyethylene, polypropylene, poly(methyl methacrylate), polyethylene terephthalate, and/or combinations thereof.

In some embodiments, an adhesive adheres the RFID tag to the roofing shingle. In some embodiments, an adhesive adheres the RFID tag to a top surface of the roofing shingle. In some embodiments, an adhesive adheres the RFID tag to a bottom surface of the roofing shingle. In some embodiments, an adhesive adheres the RFID tag to a top surface of a layer of the roofing shingle. In some embodiments, an adhesive adheres the RFID tag to a bottom surface of a layer of the roofing shingle. In some embodiments, the RFID tag is embedded at least partially within the interior of the adhesive. In some embodiments the RFID tag is embedded fully within the interior of the adhesive.

In some embodiments, the adhesive comprises an asphalt-based adhesive. In some embodiments, the asphalt-based adhesive comprises polymer-modified asphalt. In some embodiments, the adhesive comprises a non-asphalt-based adhesive. In some embodiments, the adhesive comprises polyurethanes, epoxies, tackified polymers (SBS, SIS, SEBS, EVA, butyl vinyl acetate), maleated polyolefin, epoxidized polyolefin, epoxidized vegetable oil and derivatives, and/or combinations thereof.

In some embodiments, a tape strip adheres the RFID tag to the roofing shingle. In some embodiments, a tape strip adheres the RFID tag to a top surface of the roofing shingle. In some embodiments, a tape strip adheres the RFID tag to a bottom surface the roofing shingle. In some embodiments, a tape strip adheres the RFID tag to a top surface of a layer of the roofing shingle. In some embodiments, a tape strip adheres the RFID tag to a bottom surface of a layer of the roofing shingle. In some embodiments, the tape strip comprises a film and an adhesive. In some embodiments, the RFID tag is at least partially within the adhesive. In some embodiments the RFID tag is fully within the adhesive. In some embodiments, the film of the tape strip comprises polyethylene, polyethylene terephthalate, poly(methyl methacrylate), and/or combinations thereof. In some embodiments, the adhesive of the tape strip comprises polyurethanes, epoxies, tackified polymers (SBS, SIS, SEBS, EVA, butyl vinyl acetate), maleated polyolefin, epoxidized polyolefin, epoxidized vegetable oil and derivatives, and/or combinations thereof.

In some embodiments, the RFID tag is on or below the headlap portion of the roofing shingle. In some embodiments, the RFID tag is on or below the reveal portion of the roofing shingle. In some embodiments, the RFID tag is outside of the nail zone of the roofing shingle. In some embodiments, the RFID tag is within the nail zone of the roofing material.

In some embodiments, the roofing shingle comprises a release tape. In some embodiments, the RFID tag is on a surface of the release tape. In some embodiments, the RFID tag is embedded partially or fully within the release tape. In some embodiments, the roofing shingle comprises sealant on the top surface. In some embodiments, the roofing shingle comprises sealant on the bottom surface. In some embodiments, the RFID tag is on a surface of the sealant. In some embodiments, the RFID tag is embedded at least partially within the interior of the sealant. In some embodiments, the RFID tag is embedded fully within the interior of the sealant.

In some embodiments, the roofing shingle includes more than one RFID tag. In some embodiments, the roofing shingle includes two RFID tags. In some embodiments, the roofing shingle includes more than two RFID tags.

In some embodiments, the RFID tag is between layers of the roofing shingle. In some embodiments, the roofing shingle comprises a first shingle portion and a second shingle portion, and the RFID tag is between the first shingle portion and the second shingle portion. In some embodiments, the roofing shingle comprises a first shingle portion, a second shingle portion, and a third shingle portion, and the RFID tag is between the first shingle portion and the second shingle portion, or between the second shingle portion and the third shingle portion. In some embodiments, the roofing shingle comprises a first shingle portion, a second shingle portion, a third shingle portion, and a fourth shingle portion, and the RFID tag is between the first shingle portion and the second shingle portion, or between the second shingle portion and the third shingle portion, or between the third shingle portion and the fourth shingle portion.

In some embodiments, the first shingle portion has a base portion, and at least one tooth portion extending from the base portion. In some embodiments, the at least one tooth portion comprises a first tooth portion. In some embodiments, the at least one tooth portion comprises at least a first tooth portion. In some embodiments, the at least one tooth portion comprises a first tooth portion and a second tooth portion (that is, two tooth portions). In some embodiments, the at least one tooth portion comprises a first tooth portion, a second tooth portion, and a third tooth portion (that is, three tooth portions). In some embodiments, the at least one tooth portion comprises four tooth portions. In some embodiments, the at least one tooth portion comprises five tooth portions. In some embodiments, the at least one tooth portion comprises six tooth portions. In some embodiments, the at least one tooth portion comprises seven tooth portions. In some embodiments, the at least one tooth portion comprises eight tooth portions. In some embodiments, the at least one tooth portion comprises nine tooth portions. In some embodiments, the at least one tooth portion comprises ten tooth portions. In some embodiments, the at least one tooth portion comprises more than ten tooth portions.

In some embodiments, the base portion has a top surface, and a bottom surface opposite the top surface. In some embodiments, each of the plurality of tooth portions has a top surface, and a bottom surface opposite the top surface.

In some embodiments, the second shingle portion has a top surface, and a bottom surface opposite the top surface. In some embodiments, the first shingle portion at least partially overlaps the second shingle portion, thereby forming the roofing shingle. In some embodiments, the first shingle portion and the second shingle portion are adhered to one another. In some embodiments, the first shingle portion and the second shingle portion are adhered to one another by an adhesive line. In some embodiments, the first shingle portion is pressed into the second shingle portion. In some embodiments, the second shingle portion is pressed into the first shingle portion. In some embodiments, the first shingle portion is pressed into the second shingle portion, and the second shingle portion is pressed into the first shingle portion. In some embodiments, the first shingle portion and the second shingle portion are adhered to one another by an adhesive line, and the first shingle portion is pressed into the second shingle portion. In some embodiments, the first shingle portion and the second shingle portion are adhered to one another by an adhesive line, and the second shingle portion is pressed into the first shingle portion. In some embodiments, the first shingle portion and the second shingle portion are adhered to one another by an adhesive line, and the first shingle portion is pressed into the second shingle portion. In some embodiments, the first shingle portion and the second shingle portion are adhered to one another by an adhesive line, and the first shingle portion is pressed into the second shingle portion and the second shingle portion is pressed into the first shingle portion.

In some embodiments, at least one adhesive line adheres the bottom surface of the first tooth portion to the top surface of the second shingle portion. In some embodiments, the at least one adhesive line adheres the bottom surface of the base portion to the second shingle portion. In some embodiments, the at least one adhesive line adheres the bottom surface of the tooth portion to the second shingle portion.

In some embodiments, the at least one adhesive line comprises at least one adhesive line on the bottom of the base portion. In some embodiments, the at least one adhesive line comprises one adhesive line on the bottom of the base portion. In some embodiments, the at least one adhesive line comprises two adhesive lines on the bottom of the base portion. In some embodiments, the at least one adhesive line comprises three adhesive lines on the bottom of the base portion. In some embodiments, the at least one adhesive line comprises four adhesive lines on the bottom of the base portion. In some embodiments, the at least one adhesive line comprises more than four adhesive lines on the bottom of the base portion. In some embodiments, one or more, or all, or none, of the adhesive line or lines are between the bottom of the base portion and the top portion of the second shingle portion. In some embodiments, one or more, or all, or none, of the adhesive line or lines are between the bottom of the tooth portion or portions and the top portion of the second shingle portion.

In some embodiments, the at least one adhesive line comprises at least one adhesive line on the bottom of the tooth portion. In some embodiments, the at least one adhesive line comprises one adhesive line on the bottom of the tooth portion. In some embodiments, the at least one adhesive line comprises two adhesive lines on the bottom of the tooth portion. In some embodiments, the at least one adhesive line comprises three adhesive lines on the bottom of the tooth portion. In some embodiments, the at least one adhesive line comprises four adhesive lines on the bottom of the tooth portion. In some embodiments, the at least one adhesive line comprises more than four adhesive lines on the bottom of the tooth portion.

In some embodiments, the adhesive line or adhesive lines are on one tooth portion. In some embodiments, the adhesive line or adhesive lines are on two tooth portions. In some embodiments, the adhesive line or adhesive lines are on three tooth portions. In some embodiments, the adhesive line or adhesive lines are on four tooth portions. In some embodiments, the adhesive line or adhesive lines are on five tooth portions. In some embodiments, the adhesive line or adhesive lines are on six tooth portions. In some embodiments, the adhesive line or adhesive lines are on seven tooth portions. In some embodiments, the adhesive line or adhesive lines are on eight tooth portions. In some embodiments, the adhesive line or adhesive lines are on nine tooth portions. In some embodiments, the adhesive line or adhesive lines are on ten tooth portions. In some embodiments, the adhesive line or adhesive lines are on more than ten tooth portions. In some embodiments, the adhesive line or adhesive lines are on all of the tooth portions. In some embodiments, the adhesive line or adhesive lines are on less than all of the tooth portions.

In some embodiments, the RFID tag is embedded within the adhesive line. In some embodiments, the RFID tag is on a surface of the adhesive line. In some embodiments, the RFID tag is on a surface of the adhesive line which is in contact with the top surface of the second shingle portion (for example, a bottom or bottommost surface of the adhesive line). In some embodiments, the RFID tag is on a surface of the adhesive line which is in contact with the bottom surface of the first shingle portion (for example, an upper or uppermost surface of the asphalt-filled layer). In some embodiments, the RFID tag is embedded at least partially within the interior of the adhesive line. In some embodiments, the RFID tag is embedded fully within the interior of the adhesive line.

In some embodiments, either or both of the first shingle portion and/or the second shingle portion may be as described above—for example, either or both of the first shingle portion and/or the second shingle portion may comprise one or more, or all, or none, of the substrate, the asphalt-filled layer, the plurality of granules, and/or the bottom layer, as described.

In some embodiments, the roofing shingle is a non-asphalt shingle that includes the RFID tag. In some embodiments, the non-asphaltic roofing shingle is as disclosed in US 2020/0224419, titled “Non-Asphaltic Coatings, Non-Asphaltic Roofing Materials, and Methods of Making Thereof,” which is incorporated by reference herein in its entirety. In some embodiments, the non-asphaltic roofing shingle is as disclosed in US 2023/0024411, titled “Coatings for Roofing Materials and Related Methods,” which is incorporated by reference herein in its entirety.

In some embodiments, the present invention provides a roofing system comprises at least one roofing shingle with the RFID tag, installed on or above the roof deck. In some embodiments, the roofing system comprises one roofing shingle with the RFID tag, installed on or above the roof deck. In some embodiments, the roofing system comprises more than one roofing shingle with the RFID tag, installed on or above the roof deck. In some embodiments, a majority of the roofing shingle in the roofing system, installed on or above the roof deck, include RFID tags. In some embodiments, all of the roofing shingle in the roofing system, installed on or above the roof deck, include RFID tags.

In some embodiments, the present invention provides a shingle bundle. In some embodiments, at least one of the roofing shingles in the shingle bundle includes the RFID tag. In some embodiments, one of the roofing shingles in the shingle bundle includes the RFID tag. In some embodiments, more than one of the roofing shingles in the shingle bundle includes the RFID tag. In some embodiments, a majority of the roofing shingles in the shingle bundle includes the RFID tag. In some embodiments, all of the roofing shingles in the shingle bundle includes the RFID tag.

In some embodiments, the present invention provides a pallet comprising more than one bundle of roofing shingles. In some embodiments, at least one of the roofing shingles on the pallet includes the RFID tag. In some embodiments, one of the roofing shingles on the pallet includes the RFID tag. In some embodiments, more than one of the roofing shingles on the pallet includes the RFID tag. In some embodiments, a majority of the roofing shingles on the pallet includes the RFID tag. In some embodiments, all of the roofing shingles on the pallet includes the RFID tag.

In some embodiments, at least one of the RFID tags may be configured to provide at least one or any combination of the following information: date of manufacture, time of manufacture, place of manufacture, date of packaging, time of packaging, place of packaging, one or more materials used in the roofing shingle, one or more processes used to manufacture the shingle, information related to movement of the shingle after manufacture, shingle type, warrantee information, special handling information (e.g., “do not mix,” “do not double stack.”), properties of the shingle (e.g., Class 4 impact resistance, recycled material content, etc.), and/or other information.

In some embodiments, the RFID tags may be able to withstand high temperatures, such as a temperature of at least 400 degrees Fahrenheit, which may be a temperature at which the asphalt-filled layer is applied to the substrate of the roofing shingle. In some embodiments, the RFID tags may be able to withstand a temperature of least 300 degrees Fahrenheit, which may be a temperature at which the adhesive line is applied to the roofing shingle.

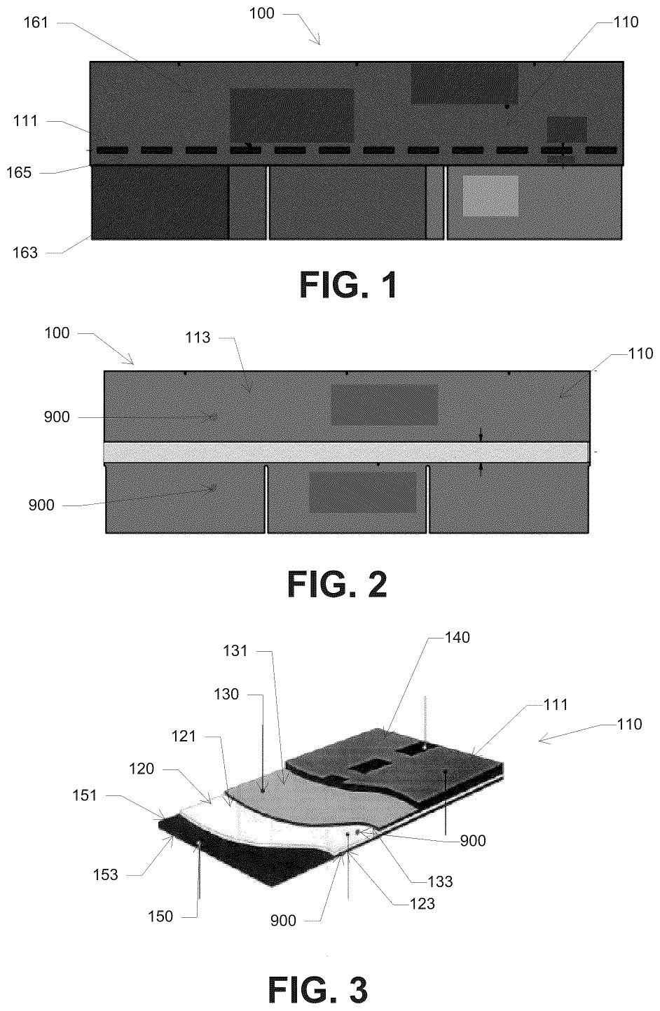

With reference to the figures, FIG. 1 shows a top view of a roofing shingle, FIG. 2 shows a bottom view of the roofing shingle of FIG. 1, and FIG. 3 shows a cross-sectional view of the roofing shingle of FIG. 1, according to some embodiments. As shown in FIGS. 1-3, and as described, a roofing shingle 100 may include a first shingle portion 110. The first shingle portion 110 may comprise a top surface 111, and a bottom surface 113 opposite the top surface 111, as described.

The first shingle portion 110 may comprise a substrate 120, as described. The substrate 120 may comprise a top surface 121, and a bottom surface 123 opposite the top surface 121. The first shingle portion 110 may comprise an asphalt-filled layer 130, which may comprise a top surface 131 and a bottom surface 133. The bottom surface 133 of the asphalt-filled layer may at least partially coat the top surface 121 of the substrate. The first shingle portion 110 may comprise a plurality of granules 140, as described. The plurality of granules may at least partially cover the top surface 131 of the asphalt-filled layer 130.

In some embodiments, first shingle portion 110 may comprise a bottom layer 150, the bottom layer 150 having a top surface 151, and a bottom surface 153 opposite the top surface 151. In some embodiments, the top surface 151 of the bottom layer 150 may at least partially cover the bottom surface 123 of the substrate. In some embodiments, the bottom layer 150 may be a second-asphalt filled layer, as described. In some embodiments, the bottom layer 150 may be another layer, as described. In some embodiments, another bottom layer may at least partially cover the bottom surface 153 of the bottom layer 150, such as when the bottom layer 150 is a second asphalt-filled layer.

In accordance with some embodiments, the figures show exemplary locations of one or more RFID tags 900, as described. In some embodiments, the one or more RFID tags 900 may be embedded at least partially within an interior of, embedded fully within an interior of, or disposed on, any or all of the following: the top surface 111 of the first shingle portion 110; the bottom surface 113 of the first shingle portion 110; the plurality of granules 140; the top surface 131 of the asphalt-filled layer 130; an interior of the asphalt-filled layer 130; the bottom surface 133 of the asphalt-filled layer 130; the top surface 121 of the substrate 120; an interior of the substrate 120; the bottom surface 123 of the substrate 120; the top surface 151 of the bottom layer 150; the bottom surface 153 of the bottom layer 150; an interior of the bottom layer 150; a top and/or bottom surface of any other layer on the bottom layer 150; and/or any other layer, layer, or sublayer of the roofing shingle 100, as described.

In some embodiments, the one or more RFID tags 900 may be taped to the first shingle portion 110, as described. In some embodiments, the one or more RFID tags 900 may be adhered to the first shingle portion 110, as described. In some embodiments, the one or more RFID tags 900 may be embedded during manufacturing of the first shingle portion 110, as described.

In some embodiments, the top surface 111 may comprise a headlap portion 161, a reveal portion 163, and a nail zone 165 between the headlap portion 161 and the reveal portion 163. In some embodiments, the nail zone 165 may include the plurality of granules 140. In some embodiments, the nail zone 165 may omit granules. In some embodiments, the nail zone 165 may comprise a plurality of fines.

In some embodiments, the one or more RFID tags 900 may be on or below the headlap portion 161, as described. In some embodiments, the one or more RFID tags 900 may be on or below the reveal portion 163, as described. In some embodiments, the one or more RFID tags 900 may be outside of the nail zone 165, as described. In some embodiments, the one or more RFID tags 900 may be on or below the nail zone 165, as described.

Although FIGS. 1-3 show a three-tabbed roofing shingle, it is understood that the roofing shingle 100 may be any roofing shingle, as described.

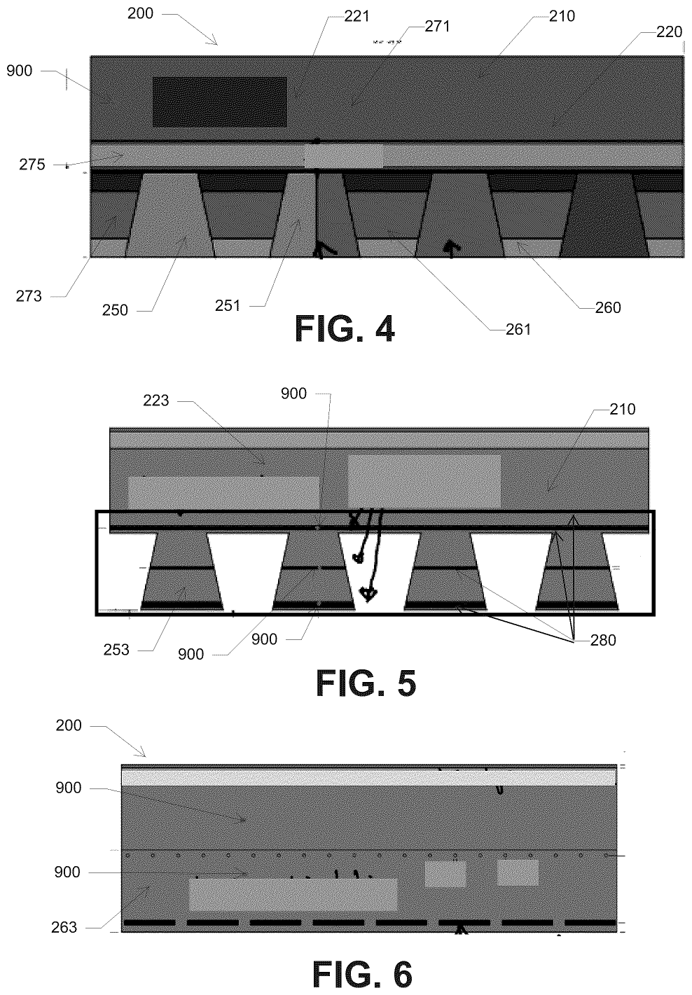

FIG. 4 shows a top view of a roofing shingle including a first shingle portion and a second shingle portion, FIG. 5 shows a bottom view of the first shingle portion of the roofing shingle of FIG. 4, and FIG. 6 shows a bottom view of the roofing shingle of FIG. 4, according to some embodiments. In some embodiments, a roofing shingle 200 may comprise a first shingle portion 210. In some embodiments, the first shingle portion 210 may comprise a base portion 220 having a top surface 221, and a bottom surface 223 opposite the top surface 221, as described. In some embodiments, the first shingle portion 210 may include a plurality of tooth portions 250, as described. Each of the tooth portions 250 may have a top surface 251 and a bottom surface 253 opposite the top surface 251. Each of the plurality of tooth portions 250 may extend from the base portion 220. As shown, in some embodiments, the roofing shingle 200 may include a second shingle portion 260, having a top surface 261 and a bottom surface 263 opposite the top surface 261, as described.

As shown in FIG. 5, in some embodiments, at least one adhesive line 280 adheres the bottom surface 253 of one or more of the tooth portions 250 to the top surface 261 of the second shingle portion 260. Also as shown, in some embodiments, at least one adhesive line 280 adheres the bottom surface 223 of the base portion 220 of the first shingle portion 210 to the top surface 261 of the second shingle portion 260.

In some embodiments, one or more of the RFID tags 900 may be embedded at least partially within an interior of, embedded fully within an interior of, or disposed on, any or all of the following: the top surface 221 of the base portion 220; the top surface 251 of the tooth portion 250; the bottom surface 223 of the base portion 220; an interior of the base portion 220; an interior of the tooth portion 250; the bottom surface 253 of the tooth portion 250; and/or one or more of the adhesive lines 280. Further, either or both of the first shingle portion 210 and/or the second shingle portion 260 may include one or more, all, or none of the layers shown in FIGS. 1-3. Thus, in some embodiments, one or more of the RFID tags 900 may be embedded at least partially within an interior of, embedded fully within an interior of, or disposed on, any or all of the following: a plurality of granules of the first shingle portion 210; a top surface of an asphalt-filled layer of the first shingle portion 210; an interior of the asphalt-filled layer of the first shingle portion 210; a bottom surface of the asphalt-filled layer of the first shingle portion 210; a top surface of a substrate of the first shingle portion 210; an interior of the substrate of the first shingle portion 210; a bottom surface of the substrate of the first shingle portion 210; a top surface of a bottom layer of the first shingle portion 210; a bottom surface of the bottom layer of the first shingle portion 210; an interior of the bottom layer of the first shingle portion 210; a top and/or bottom surface of any other layer, coating, or sublayer on the bottom layer of the first shingle portion 210; a plurality of granules of the second shingle portion 260; a top surface of an asphalt-filled layer of the second shingle portion 260; a bottom surface of the asphalt-filled layer of the second shingle portion 260; an interior of the asphalt-filled layer of the second shingle portion 260; a top surface of a substrate of the second shingle portion 260; an interior of the substrate of the second shingle portion 260; a bottom surface of the substrate of the second shingle portion 260; a top surface of a bottom layer of the second shingle portion 260; a bottom surface of the bottom layer of the second shingle portion 260; an interior of the bottom layer of the second shingle portion 260; a top and/or bottom surface of any other layer, coating, or sublayer on the bottom layer of the second shingle portion 260.

In some embodiments, the top surface 221 of the base portion 220, the top surface 251 of the one or more tooth portions 250, and/or the top surface 261 of the second shingle portion 260 may comprise a headlap portion 271, a reveal portion 273, and a nail zone 275 between the headlap portion 271 and the reveal portion 273. In some embodiments, the nail zone 275 may include the plurality of granules. In some embodiments, the nail zone 275 may omit granules. In some embodiments, the nail zone 275 may comprise a plurality of fines.

In some embodiments, the one or more RFID tags 900 may be on or below the headlap portion 271, as described. In some embodiments, the one or more RFID tags 900 may be on or below the reveal portion 273, as described. In some embodiments, the one or more RFID tags 900 may be outside of the nail zone 265, as described. In some embodiments, the one or more RFID tags 900 may be on or below the nail zone 275, as described.

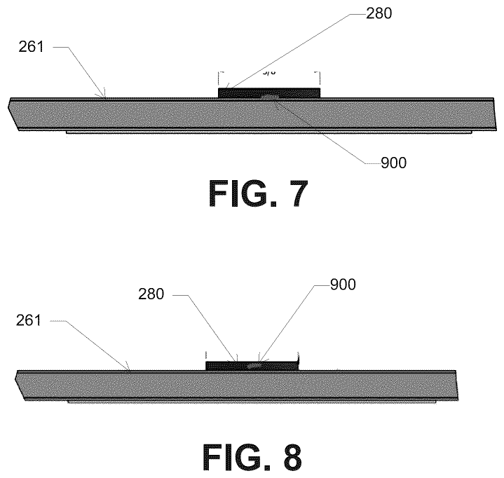

As discussed, as shown in FIGS. 7 and 8, in some embodiments, one or more of the RFID tag 900 may be embedded fully within an interior of the adhesive line 280, and/or may be on embedded partially within an interior of the adhesive line 280, such that the one or more RFID tags are on a surface of the adhesive line 280.

Locating the RFID tag within the roofing shingle, or between layers of the roofing shingle, or otherwise hidden from observation, may provide advantages as compared to an RFID tag located on a surface of the roofing shingle. By way of example, the advantages may include one or more of protection of the RFID tag from damage during handling and after installation; protection of the RFID tag from tampering; and/or protection of the RFID tag from the elements.

In some embodiments, the RFID tag may be read by an RFID tag reader, without contacting the reader to either the RFD tag and/or the roofing shingle. In some embodiments, the RFID tag reader may be held on the top surface of the roofing shingle. In some embodiments, the RFID tag reader may be held above the top surface of the roofing shingle.

Variations, modifications, and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A roofing shingle, comprising:
a first shingle portion, comprising:
a base portion, and
a plurality of tooth portions extending from the base portion,
wherein the plurality of tooth portions comprises at least a first tooth portion;
a second shingle portion positioned to at least partially overlap the first shingle portion;
a first adhesive line between the first tooth portion and the second shingle portion; and
an RFID tag in the first adhesive line.

2. The roofing shingle of claim 1, wherein the RFID tag is fully within an interior of the first adhesive line.

3. The roofing shingle of claim 1, wherein the RFID tag is on a surface of the first adhesive line.

4. The roofing shingle of claim 3, wherein the RFID tag is on a surface of the first tooth portion.

5. The roofing shingle of claim 3, wherein the RFID tag is a surface of the second shingle portion.

6. The roofing shingle of claim 1, wherein the first adhesive line comprises an asphalt-based adhesive or a non-asphalt-based adhesive.

7. The roofing shingle of claim 1, wherein the first tooth portion comprises:
a substrate;
an asphalt-filled layer on the substrate; and
a plurality of granules on the asphalt-filled layer.

8. The roofing shingle of claim 7, wherein the substrate comprises a fiberglass mat.

9. The roofing shingle of claim 1, further comprising a second adhesive line between the first tooth portion and the second shingle portion.

10. The roofing shingle of claim 9, further comprising a third adhesive line between the base portion and the second shingle portion.

11. A roofing shingle, comprising:
a substrate;
a first asphalt-filled layer on the substrate;
a plurality of granules on the first asphalt-filled layer; and
an RFID tag on the substrate,
wherein at least a portion of the first asphalt-filled layer covers the RFID tag.

12. The roofing shingle of claim 11, further comprising:
a second asphalt-filled layer,
wherein the first asphalt-filled layer and the second asphalt-filled layer are on opposite sides of the substrate.

13. The roofing shingle of claim 11, wherein the substrate comprises a fiberglass mat.

14. The roofing shingle of claim 11, wherein the roofing shingle includes a headlap portion and a reveal portion,
wherein RFID tag is below the headlap portion.

15. The roofing shingle of claim 11, wherein the roofing shingle includes a headlap portion and a reveal portion,
wherein the RFID tag is below the reveal portion.

16. A roofing system, comprising:
a roof deck; and
a roofing shingle installed on the roof deck, the roofing shingle comprising:
a first shingle portion, comprising:
a base portion; and
a plurality of tooth portions extending from the base portion,
wherein the plurality of tooth portions comprises at least a first tooth portion;
a second shingle portion positioned to at least partially overlap the first shingle portion;
a first adhesive line between the first tooth portion and the second shingle portion; and
an RFID tag in the first adhesive line.

17. The roofing system of claim 16, wherein the RFID tag is fully within an interior of the first adhesive line.

18. The roofing system of claim 16, wherein the RFID tag is on a surface of the first adhesive line.

19. The roofing system of claim 16, wherein the RFID tag is on a surface of the first tooth portion.

20. The roofing system of claim 16, wherein the RFID tag is a surface of the second shingle portion.
